(19) United States
(12) Patent Application Publication
(10) Pub. No.: US 2003/0191960 A1
(43) Pub. Date: Oct. 9, 2003

(54) Computer lock system with time-control function

(75) Inventor: Yang Hung-yi, Changhua Hsien (TW)

Correspondence Address: BACON & THOMAS, PLLC, 625 SLATERS LANE, FOURTH FLOOR, ALEXANDRIA, VA, 22314

(73) Assignee: Wind Technology Ltd., Changhua Hsien (TW)

(21) Appl. No.: 10/118,152

(22) Filed: Apr. 9, 2002

(51) Int. Cl. G06F 12/14; H04L 9/32

(52) U.S. Cl. 713/200; 713/500

(57) ABSTRACT

A computer lock system with time-control function consists of a main program to supervise the right and time of using the computer system by authorized users, and a subprogram to process and store basic data such as the entry of the users for ID examination and the setting of time-limit for using the computer system. Said main program thereof, once checked by a BootRom chip on a protect card and executed in an operating system, will start an internal clock for time-control and a screen saver to keep the computer system locked in wait for the access of an authorized user passing the ID examination so as to protect the computer system from the illegal use of the crackers and secure the right of the users. When the time-limit of using the computer system is up, said main program thereof will restart said screen saver to keep the computer system locked again in wait for another legal user, thus efficiently protecting the right and regulating the time of using the computer system by the users. Beside supervising the operating system on PC, said computer lock system thereof can also combine with the operation of network to supervise and manage the computer systems on workstations.

### BACKGROUND OF THE INVENTION

The present invention is related to a computer lock system with time-control function which supported by a protect card, a card reader, and several IC cards can supervise the legal use of the computer systems by authorized users during pre-set time-limit so as to efficiently manage the right and time of using the computer system, protecting the right of the users from the crackers and preventing the computer system from being occupied and overused by a single user as well.

Nowadays, computers are indispensable for different purposes like education and entertainment. People of different ages become increasingly dependent on this useful tool in their daily lives. Sometime, people, especially the young kids, forget the importance of time-control when using the computers. Or, when in school or classes, computers are tended to be occupied and overused by a certain small number of the students. In other case, when computers are used for commercial purposes as in the inter-net café or in the video-game shop, it is quite uneconomical to count the using-time of the customers in a manual way.

### SUMMARY OF THE PRESENT INVENTION

It is, therefore, the primary purpose of the present invention to provide a computer lock system with time-control function, having a main program which supported a by a protect card, a card reader, and several IC cards can supervise the legal use of the computer systems by authorized IC card holders during pre-set time-limit, and a subprogram which can process and store the basic data such as the entry of the IC card holders for ID examination and the setting of time-limit for using the computer system for each IC card holder so as to efficiently protect the right of the users from the crackers and prevent the computer system from being occupied and overused by a single user as well.

### BRIEF DESCRIPTION OF THE DRAWINGS

FIGS. 1-1, 1-2 are block flow charts of the main program of the present invention.

FIG. 2-1, 2-2 are block flow charts of the subprogram of the present invention.

FIG. 3-1, 3-2 are another block flow charts showing the main program of the present invention.

### DETAILED DESCRIPTION OF THE PREFERRED EMBODIMENTS

The present invention is related to a computer lock system with time-control function which, supported by a protect card, a card reader, and several IC cards to be distributed to different users, can supervise the legal use of the computer systems by authorized users during pre-set time-limit so as to efficiently protect the right of the users from the crackers and control the using-time of the computer system by the users.

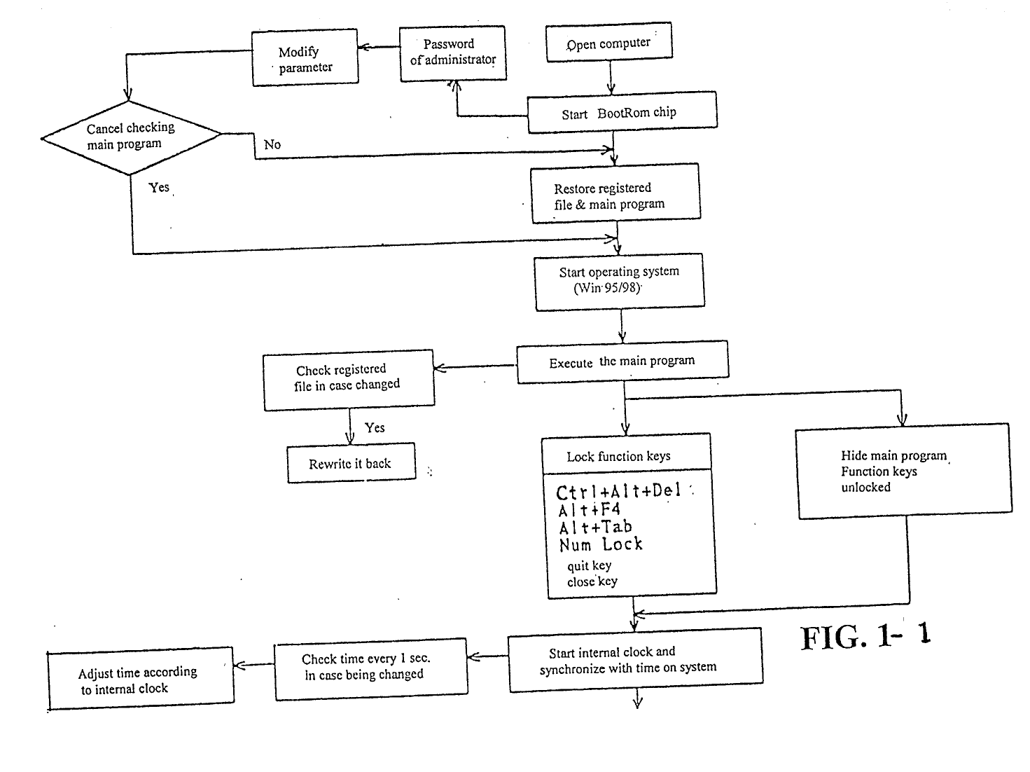

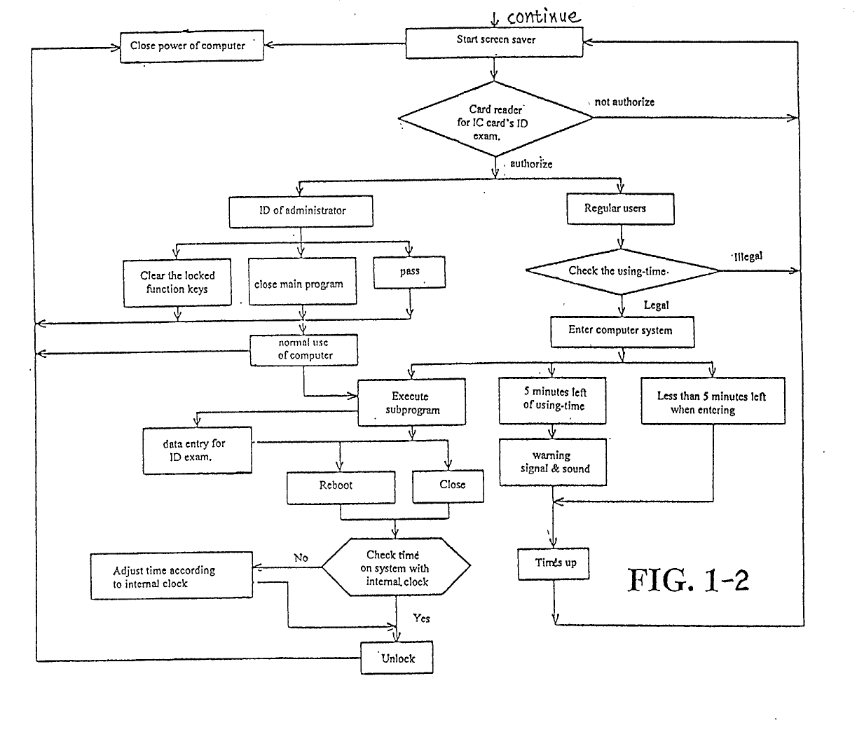

Please refer to FIG. 1 showing the flow chart of the main program of the present invention. When the computer is opened, a BootRom chip on the protect card will start to run and begin to check the main program of said computer lock system thereof to see if said lock system is found in the computer. If not, the BootRom chip will be reset; if yes, it will then go on to the next step. Alternatively, a manager system can be selected after said BootRom chip on the protect card is started. Inputting the password of the system administrator, a user can choose either to cancel the examination of said main program thereof or not. If said examination is canceled, the computer will proceed to a normal operation before the main program thereof is restored and the computer rebooted. But if not canceled, said examination of said main program will continue till it is found in the computer. In the next step, operating systems (WIN95/98) are opened and then the main program of said computer lock system thereof executed. The function keys of the system(Ctrl+Alt+Del, Alt+F4, Alt+Tab, Num Lock, Quit and Close keys) will be locked to prevent said main program from being closed by the users carelessly. Otherwise, the main program of said computer lock system can be saved in a hidden file without locking any function keys(because the users will not be able to find and close the main program in a hidden file). While the main program is executed, said computer lock system will constantly check the registered file of the system to see if it has been modified. If so, said computer lock system will write it back automatically.

In the next step after the function keys are locked, an internal clock within the main program thereof will be started and synchronized with the time received from the clock of the current computer system. Then every one second, said internal clock thereof will check the time on the computer system to see if it has been changed. If so, the time on the computer system will be adjusted according to that of said internal clock by said main program thereof. After setting off said internal clock thereof, said main program thereof will start a screen saver to keep the computer locked in wait for the access of a user who has to insert an IC card and pass an ID examination before gaining access to the computer system. Without an authorized IC card, a user can only choose to close and leave the computer.

When the IC card is authorized as system administrator in the ID examination, the user can choose any of the following instructions—clear the locked function keys, close the main program thereof, or simply pass—and then proceed to a normal operation of the computer system. Afterwards, the user can choose either to close the computer or to execute a subprogram of said computer lock system wherein the entry of basic data for ID examination is processed and stored. After finishing the processing of basic data thereof, the user can select either to close or reboot the computer. When the computer system is rebooted, said main program thereof will start said internal clock thereof and check the time every one second to keep the time in synchronization without being changed. When the IC card is authorized as a regular user in the ID examination, the time-limit of using the computer system pre-set for the authorized user is checked to see if it is the legal for said user to use the computer system. If not, the user is required to reconfirm the ID, or simply to close and leave the computer. When the legal use of the computer is authorized, the user is then permitted the access to the computer. Then, within five minutes before the time of using the computer running out, said main program thereof will send out a warning signal and sound to remind the user of the time-limit. Or, there may be less than five minutes left for using the computer when the user first enters the computer. In either case, when the pre-set using time is up, said main program thereof will automatically start said screen saver to keep the computer locked in wait for another legal user to insert the IC card for the access to the computer system or for the present user to close and leave the computer system. In other case, a regular user can also execute said subprogram thereof providing the account no. and password of the system administrator necessary for the access to said subprogram thereof are given and authorized.

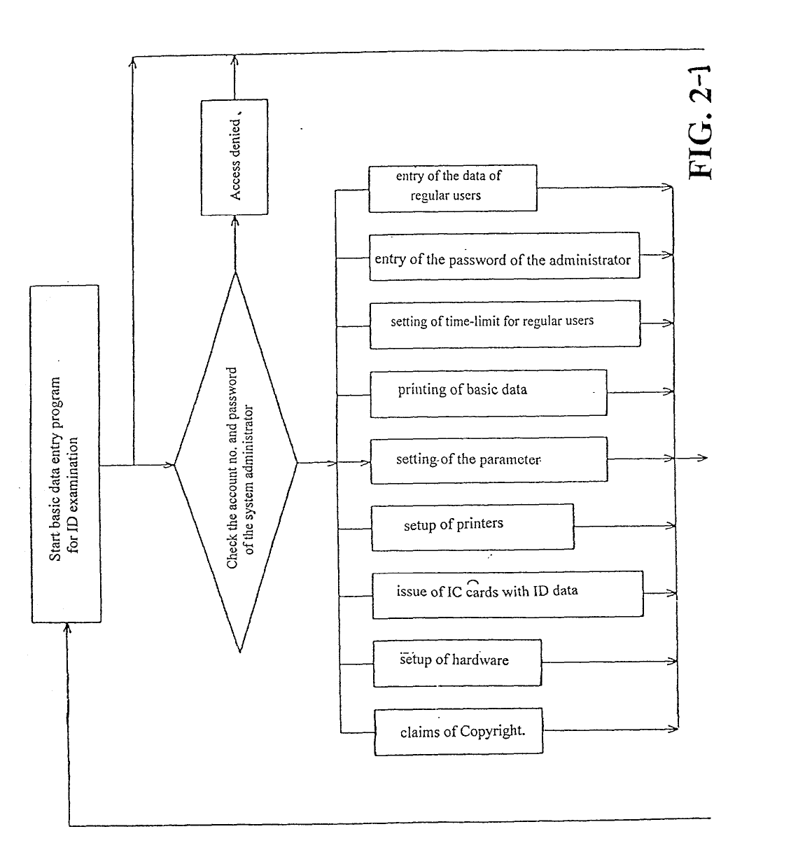

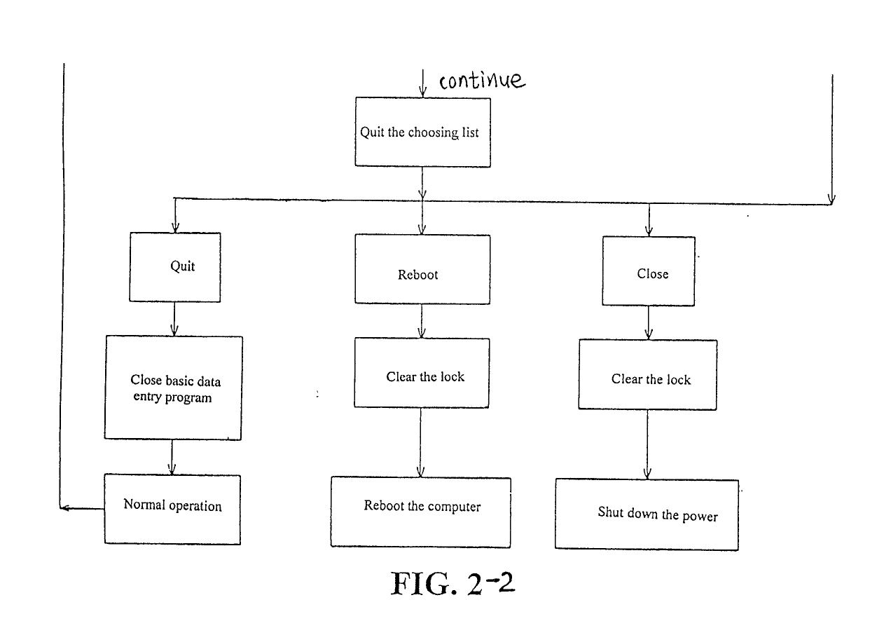

Please refer to FIG. 2 showing the block flow chart of the subprogram thereof. When the subprogram of said computer lock system thereof is chosen in the operating system, a user can start the program for processing basic data for ID examination and enter the manager system. Before allowed the access to said ID entry program, the user must input the correct account no. and password of the system administrator. If wrong, the user will not be allowed the access. Till the correct account no. and password are input, the user can choose only to quit, reboot, or close the computer. Once passing the ID examination, the user is allowed to enter the manager system and select from a choosing list which can process and store basic data as follows:

a. the claims of Copyright.

b. the setup of hardware.

c. the issue of IC cards with ID data.

d. the setup of printers, wherein a printer can be selected when two or more than two printers are found in the system.

e. the setting of the parameter of the system thereof.

f. the printing of basic data, wherein the basic data of the IC card holders can be printed out when there are many of them.

g. the setting of time-limit, wherein the administrator can set down a time-limit in using the computer system for each IC card holder.

h. the entry of the password of the system administrator, wherein the administrator is allowed to change the password if necessary.

i. the entry of basic data, wherein the data of the regular users is input and stored.

The processed data input in said ID entry program will be transferred to the main program of said computer lock system thereof for authorization.

Once out of the choosing list, the user will have three selections. First, the user can choose to quit said ID entry program and go back to a normal use of the computer. Second, the user can choose to reboot the computer; wherein the locked function keys will be cleared and said computer lock system closed before the computer is rebooted. Third, the user can choose to close the computer; wherein the function keys and said computer lock system will be cleared and closed before the power of the computer is shut down.

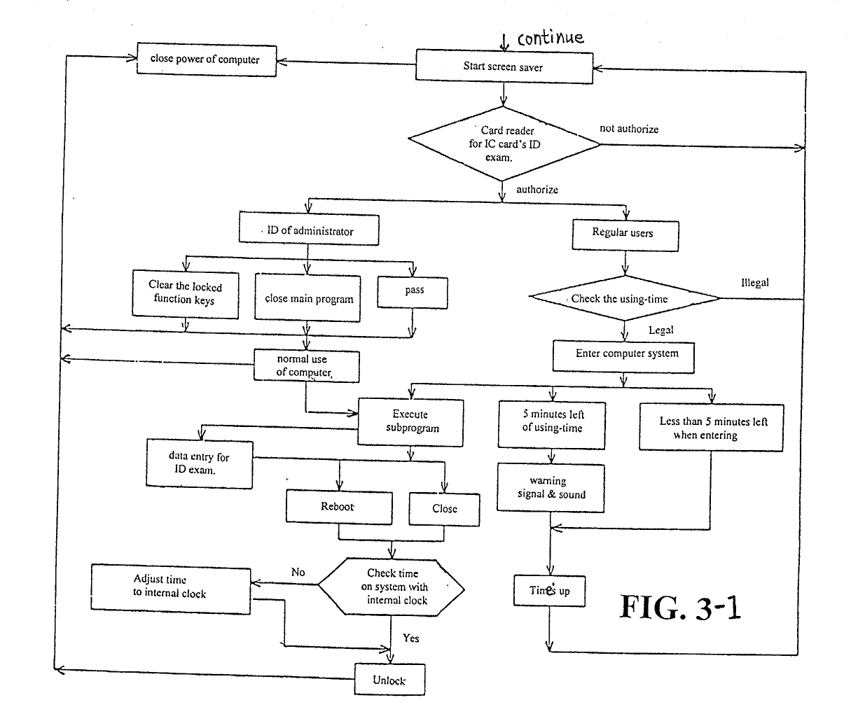

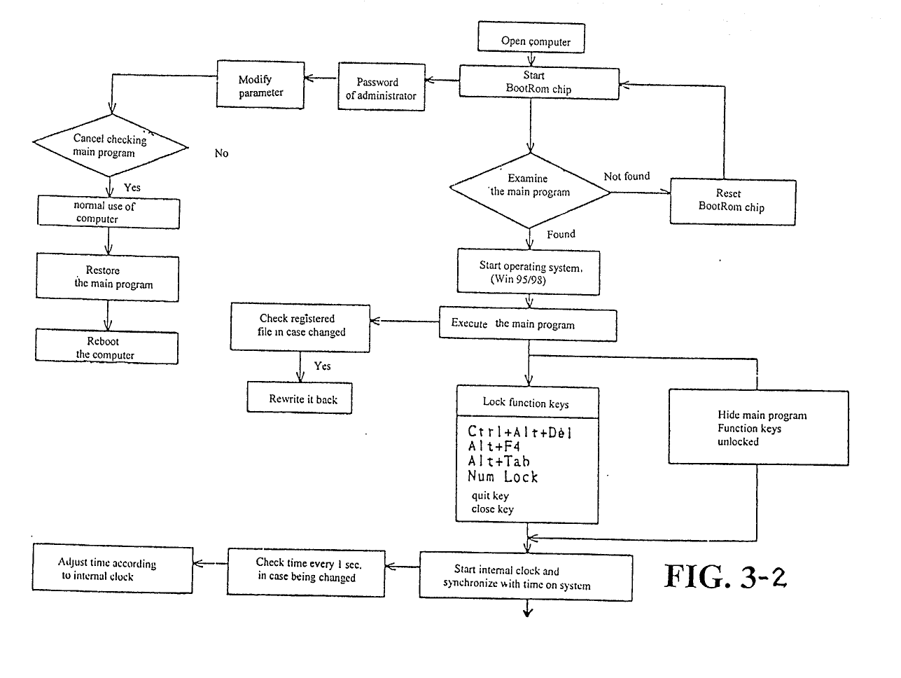

Please refer to FIG. 3 showing another block flow chart of the main program of the present invention. When said BootRom chip on the protect card is started, the registered file and said main program thereof are directly restored and then executed without having said main program thereof checked first in the system. In other case, the manager system can be chosen after the BootRom chip is started. After inputting the account no. and password, the administer can choose either to cancel the restoration or not, and then proceed to a normal operation of the computer system before the main program of said computer lock system thereof is restored and then the computer is rebooted.

What is claimed is:

1. A computer lock system with time-control function, especially, a computer lock system having a main program which, after being checked by a BootRom chip on a protect card and executed in an operating system, will start an internal clock for time-control and a screen saver to keep the computer system locked in wait for the access of authorized users passing the ID examination so as to supervise the legal use of the computer system by authorized users during pre-set time-limit, protecting the right of the users from the crackers and regulating the using-time of the computer system as well; wherein said main program thereof includes the supervising steps as follows:
special function keys of the operating system being locked or said main program being directly saved in a hidden file after said computer lock system being started and executed;
an internal clock of said main program thereof being started and synchronized with the time received from the clock of the current computer system;
said internal clock thereof, as the standard for time-control, checking and correcting, if necessary, the time on the current computer system every one second; meanwhile said main program starting a screen saver and keeping the computer system locked in wait for the access of authorized users;
before allowed the access to the computer system, a user, inputting basic data such as account no. and password into the computer system, must be examined and authorized by said main program thereof which will decide whether said user having the legal right to use the computer system during pre-set time-limit so as to efficiently ensure the right of authorized users and regulate the using-time of the computer system;
after the user passing the ID examination, said main program thereof unlocking said screen saver and the computer system proceeding to a normal operation by said authorized user during a pre-set time-limit; otherwise, said main program will keep the computer system locked till the user reconfirming and passing the ID examination, or simply quitting the computer system;
after a legal access to the computer system, said internal clock starting the counting of time for time-control and, at a certain pre-set time, sending out warning signal and sound to remind the user that the pre-set time-limit is coming to an end soon;
once passing the pre-set using-time, said main program thereof restarting the screen saver, and keeping the computer system locked in wait for the access of another authorized user so as to enhance the security of the computer system with efficient time-control.

2. The computer lock system with time-control function as claimed in claim 1 wherein a BootRom program, loaded in the computer system and once started, can carry out the examination of the main program of said computer lock system thereof to ensure said main program thereof being found in the computer system without being interrupted; otherwise, said BootRom chip on the protect card, not checking said main program thereof and modifying the parameter, can directly restore the registered file and said main program thereof before executing said main program thereof; or a manager system can be selected after said BootRom chip thereof being started, and said restoration of said main program thereof can be canceled with the same protect effect after the account no. and password of the system administer being input; in other case, one or more than one supervising protect programs can also be used in the system to mutually enhance the safety of said computer lock system without being interrupted.

3. The computer lock system with time-control function as claimed in claim 1 wherein said main program thereof, once started, are automatically saved in a hidden file to prevent the interruption of said main program thereof by a user via special function keys; otherwise, once said main program thereof being started, special function keys of the computer system(Ctrl+Alt+Del, Alt+F4, Alt+Tab, Num Lock, Quit and Close keys) will be locked to secure the safety of said computer lock system.

4. The computer lock system with time-control function as claimed in claim 1 wherein, besides starting the screen saver and locking the special function keys to supervise the operating system of the computer system, said computer lock system thereof can also combine with the operation of network; once being started, said main program thereof loaded on a main computer can lock the keyboards and mouse connected to the computers on the workstation till said main program thereof on said main computer sending out message to decide if to unlock said keyboards and mouse for use, thus managing and regulating the right and time of using the computer systems.

5. The computer lock system with time-control function as claimed in claim 1 wherein for authorization of the legal users of the computer system, different means can be used for ID examination: for example, directly inputting account no. and password on the keyboards, IC cards, bar code cards, magnetic cards, sensor cards, fingerprint-matching, or retina-matching, etc.

6. The computer lock system with time-control function as claimed in claim 1 wherein the ID of the user can be examined directly on PC, or, data sent out from workstation can be examined and matched by a main computer on the network to determine if to unlock the computer systems on workstation for efficient management of the right and time of using the computer systems.

7. The computer clock system with time-control function as claimed in claim 1 wherein said computer clock system has a subprogram for the processing of basic data for ID examination, in which a user, after inputting the correct account no. and password of the system administrator, can select from a choosing list for data processing including: the claims of the copyright, the setup of hardware, the issue of IC cards with ID data, the setup of printers, the setup of the parameter of the system thereof, the printing of basic data of the users, the setting of time-limit, the entry of the password of the system administrator, and the entry of basic data of the regular users, etc.; said processed data input in said ID entry program will be transferred to the main program of said computer lock system thereof for authorization of the legal access of the users to the computer system.
